(19) United States
(12) Patent Application Publication
(10) Pub. No.: US 2024/0067494 A1
(43) Pub. Date: Feb. 29, 2024

(54) METHOD AND A CONTROLLER FOR AN ELEVATOR SYSTEM

(71) Applicant: KONE Corporation, Helsinki (FI)

(72) Inventors: Mika BELOV, Helsinki (FI); Mikko PIIRONEN, Helsinki (FI); Mikko MATTILA, Helsinki (FI); Santtu KOSKINEN, Helsinki (FI)

(73) Assignee: KONE Corporation, Helsinki (FI)

(21) Appl. No.: 18/387,187

(22) Filed: Nov. 6, 2023

Related U.S. Application Data
(63) Continuation of application No. PCT/EP2021/064689, filed on Jun. 1, 2021.

(51) Int. Cl. B66B 1/34; B66B 1/06

(52) U.S. Cl. CPC B66B 1/34; B66B 1/06; B66B 2201/241

(57) ABSTRACT

A method and a controller are disclosed. The method in includes obtaining, by a controller of an elevator system, a sensor event associated with a location in a building; and changing, by the controller, the state of at least one elevator associated with the location from an idle state to an active state.

### BACKGROUND

An elevator system may comprise one or more elevators, and depending on, for example, a traffic situation or the time of day, one or more elevators may be kept in a standby mode in order to save power. If an elevator is taken back to active service only when an elevator call is obtained from a passenger, this may increase, for example, waiting times for the passengers.

### SUMMARY

According to a first aspect, there is provided a method that comprises obtaining, by a controller of an elevator system, a sensor event associated with a location in a building, and changing, by the controller, the state of an least one elevator associated with the location from an idle state to an active state In an implementation form of the first aspect, obtaining, by a controller of an elevator system, a sensor event associated with a location in a building, comprises obtaining, by the controller, the sensor event associated with the location in the building from an elevator system node, the sensor event indicating an event detected by the elevator system node.

In an implementation form of the first aspect, the event detected by the elevator system node comprises at least one of increased brightness, a motion event or a proximity event.

In an implementation form of the first aspect, the elevator system node comprises a destination operating panel, a destination guide, an intelligent landing call station or a sensor node.

In an implementation form of the first aspect, obtaining, by a controller of an elevator system, a sensor event associated with a location in a building, comprises obtaining, by the controller, the sensor event associated with the location in the building from a building system, the sensor event indicating an increased power consumption of at least one system node at the location.

In an implementation form of the first aspect, changing, by the controller, the state of an least one elevator associated with the location from an idle state to an active state, comprises changing, by the controller, the state of an elevator closest to the location.

According to a second aspect, there is provided a controller of an elevator system. The controller comprises means for obtaining a sensor event associated with a location in a building; and means for changing the state of an least one elevator associated with the location from an idle state to an active state.

In an implementation form of the second aspect, the means for obtaining are configured to obtain the sensor event associated with the location in the building from an elevator system node, the sensor event indicating an event detected by the elevator system node.

In an implementation form of the second aspect, the event detected by the elevator system node comprises at least one of increased brightness, a motion event or a proximity event

In an implementation form of the second aspect, the elevator system node comprises a destination operating panel a destination guide, an intelligent landing call station or sensor node.

In an implementation form of the second aspect, the means for obtaining are configured to obtain the sensor event associated with the location in the building from a building system, the sensor event indicating an increased power consumption of at least one system node at the location.

In an implementation form of the second aspect, the at least one elevator comprises at least one elevator in proximity with the location According to a third aspect, there is provided an elevator system comprising at least one elevator and the controller of the second aspect.

According to a fourth aspect, there is provided a computer program comprising program code, which when executed by at least one processing unit, causes the controller of the second aspect to perform the method of the first aspect.

According to a fifth aspect, there is provided a computer-readable medium comprising a computer program comprising program code which when executed by at least one processing unit, causes the controller of the second aspect to perform the method of the first aspect.

According to a sixth aspect, there is provided a controller of an elevator system. The controller comprises at least one processor, and at least one memory connected to the at least one processor. The at least one memory stores program instructions that, when executed by the at least one processor, cause the apparatus to obtain a sensor event associated with a location in a building; and change the state of an least one elevator associated with the location from an idle state to an active state.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates a system according to an example embodiment.

FIG. 1B illustrates a system according to an example embodiment.

FIG. 1C illustrates a system according to an example embodiment.

FIG. 1D illustrates a system according to an example embodiment.

FIG. 2 illustrates a flow diagram of a method according to an example embodiment.

FIG. 3 illustrates a block diagram of a controller of an elevator system according to an example embodiment.

### DETAILED DESCRIPTION

In the following some example embodiments may illustrate a solution in which a controller of an elevator system, for example, an elevator controller, may obtain a sensor event associated with a location in a building. In response to the sensor event, the controller may change the state of an least one elevator associated with the location from an idle state to an active state. The idle state may refer, for example, to a power save state or a power saving mode, and the active state may refer, for example, to a normal operating state or a power on mode.

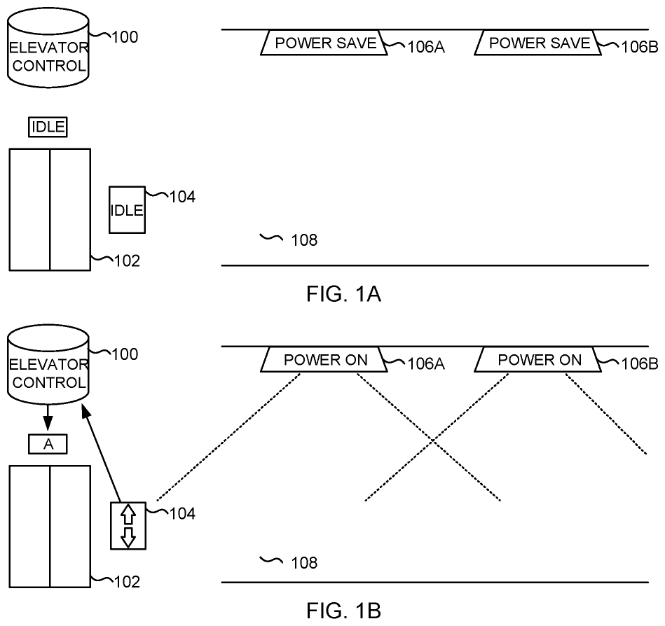

FIG. 1A illustrates a system according to an example embodiment. The example illustrated in FIG. 1A illustrates a space 108 in a building that may be close to an elevator 102. The space 108 may refer, for example, to a corridor leading to the elevator 102 or a to a space near the elevator 102.

FIG. 1A illustrates a situation in which lights 106A, 106B are operated in a power save state. In the power save state, their power consumption is significantly less than in a normal operating state or mode. They may be switched off or they may dimmed to provide only a minimum amount of brightness. This state may be applied, for example, at night.

Similarly to the lights 106A, 106B, an elevator controller 100 may keep the elevator 102 and an elevator system node 104, for example, a destination operating panel (DOP) or some other user interface node, in an idle state, i.e. in a power save state or a power saving mode.

FIG. 1B illustrates a system according to an example embodiment. Compared to FIG. 1A, in FIG. 1B at least one of the lights 106A, 106B has been switched to an active state, for example, to “power on” state. The power on state may refer to a normal state when the lights 106A, 106B are switched on. The lights 106A, 106B or the space 108 may comprise, for example, a movement detector that causes the lights 106A, 106B to be switched on when movement is detected. When the elevator system node 104 detects an event, for example, an increased brightness due to the light(s) 106A, 106B, for example, with a light detector, the elevator system node 104 may change its operating state to a normal operating state or power on state/mode, and the elevator system node 104 may be configured to transmit a sensor event to the elevator controller 100. The elevator controller 100 may by default know the identity (and thus the location) of the elevator system node 104, or alternatively the elevator system node 104 may communicate to the elevator controller 100 an identifier identifying the elevator system node 104. In response to the sensor event, the elevator controller 100 wakes up the elevator 102 to a normal operating state.

FIG. 1C illustrates a system according to an example embodiment. The system illustrated in FIG. 1C is similar to the one illustrated in FIG. 1A with the exception that FIG. 1C comprises three elevators 102A, 102B, 102C.

Each elevator 102A, 102B, 102C has an associated elevator system node 104A, 104B, 104B, for example, a destination operating panel. When the elevators 102A, 102B, 102C are not used to transport passengers, they may be operated in an idle state, i.e. a power save state or a standby mode.

FIG. 1D illustrates a system according to an example embodiment. The system illustrated in FIG. 1D is similar to the one illustrated in FIG. 1B with the exception that in FIG. 1D the system comprises three elevators 102A, 102B, 102C. In FIG. 1D, at least one of the lights 106A, 106B has been switched to an active state, for example, to “power on” state. The power on state may refer to a normal state when the lights 106A, 106B are switched on. The lights 106A, 106B or the space 108 may comprise, for example, a movement detector that causes the lights 106A, 106B to be switched on when movement is detected. The increased brightness may be detected, for example, with at least the user interface 104A that may be closest to the lights 106A, 106B. When the elevator system node 104A detects an increased brightness, for example, with a light detector, the elevator system node 104A may change its operating state to a normal operating state, and the elevator system node 104A may be configured to transmit a sensor event to the elevator controller 100. The elevator controller 100 may by default know the identity (and thus the location) of the elevator system node 104A, or alternatively the elevator system node 104A may communicate to the elevator controller 100 an identifier identifying the elevator system node 104A. In response to the sensor event, the elevator controller 100 wakes up the elevator 102A to a normal operating state.

Although FIG. 1D illustrates that only one elevator 102A is activated, in another example embodiment, the sensor event from the elevator system node 104A (or from any other elevator system node 104B, 104C) may cause activation of more than one elevator.

FIGS. 1A-1D illustrate an example in which the increased brightness detected by the elevator system node 104, 104A may be used as a trigger for transmitting a sensor event to the elevator controller 100. In another example embodiment, the elevator controller 100 may obtain the sensor event associated with the location in the building from a building system, for example, a building management system. In this case, the sensor event may indicate an increased power consumption of at least one of the lights 106A, 106B at the location. Based on this, the elevator controller 100 is then able to determine the elevator or elevators that are to be activated. In another example embodiment, the event detected by the elevator system node 104, 104A, 104B, 104C may comprise a motion event or a proximity event. The proximity event may refer to an event, which is determined by a sensor when an object, for example, a passenger comes within a specified range from the sensor.

In FIGS. 1A-1D a destination operating panel was used as an example of an elevator system node of an elevator system. In other example embodiments, other nodes may be used, for example, a destination guide, a display, an intelligent landing call station or a sensor node, for example, an Internet of Things (IoT) node.

Further, in FIGS. 1A-1D a light was used as an example of a system node associated with the increased power consumption. In other example embodiments, other nodes may be used, for example, an automatic door, an air conditioning device or another building associated device. When the node activates, its power consumption increases, and this information can be used as a sensor event.

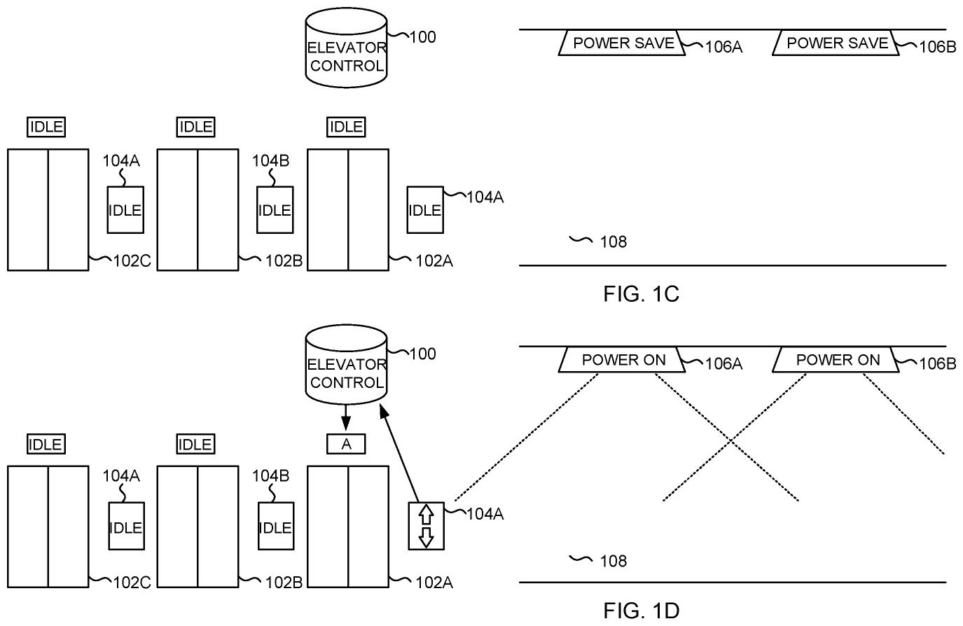

FIG. 2 illustrates a flow diagram of a method according to an example embodiment.

At 200, the method may comprises obtaining, by a controller of an elevator system, a sensor event associated with a location in a building.

At 202, the method may comprise changing, by the controller, the state of an least one elevator associated with the location from an idle state to an active state.

The method may be implemented, for example, by the elevator controller 100 of FIGS. 1A-1D.

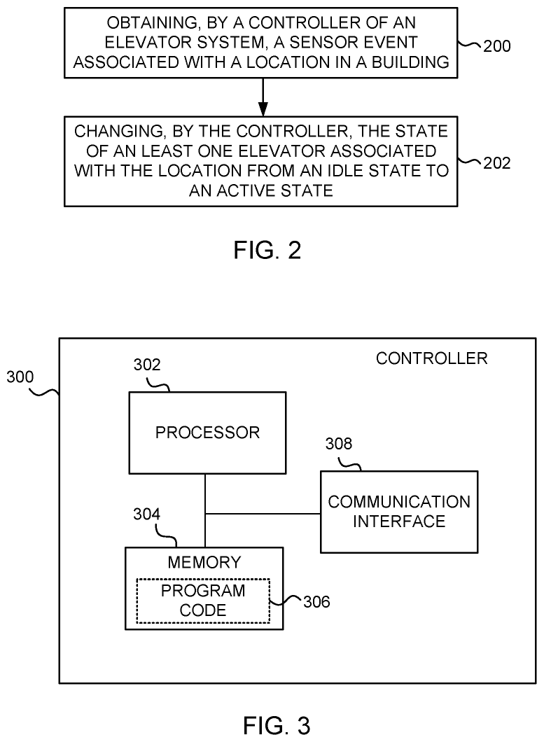

FIG. 3 illustrates a controller 300 of an elevator system according to an example embodiment. The controller 300 may be, for example, an elevator controller of an elevator system. The controller 300 may comprise at least one processor 302. The controller 300 may further comprise at least one memory 304. The memory 304 may comprise program code 306 which, when executed by the processor 302 causes the controller 300 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the controller 300 is illustrated as a single device it is appreciated that, wherever applicable, functions of the controller 300 may be distributed to a plurality of devices.

Example embodiments may be implemented in software, hardware, application logic or a combination of software, hardware and application logic. The example embodiments can store information relating to various methods described herein. This information can be stored in one or more memories 304, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 302 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s).

Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 304 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The controller 300 may comprise a communication interface 308 configured to enable the controller 300 to transmit and/or receive information, to/from other apparatuses and/or elements associated with an elevator system.

The controller 300 may comprise means for performing at least one method discussed herein. In one example, the means may comprise the at least one processor 302, the at least one memory 304 including program code 306 configured to, when executed by the at least one processor 302, cause the controller 300 to perform the method discussed hereon.

At least some of the examples and example embodiments may enable to a solution in which elevator system energy efficiency is improved. Further, at least some of the examples and example embodiments may enable to a solution in which passenger flow is improved as an elevator or elevators can be activated when a passenger approaching the elevator is detected.

While there have been shown and described and pointed out fundamental novel features as applied to preferred embodiments thereof, it will be understood that various omissions and substitutions and changes in the form and details of the devices and methods described may be made by those skilled in the art without departing from the scope of the claims. For example, it is expressly intended that all combinations of those elements and/or method steps which perform substantially the same function in substantially the same way to achieve the same results are within the scope of the claims.

Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the claims.

1. A method comprising:
obtaining, by a controller of an elevator system, a sensor event associated with a location in a building; and
changing, by the controller, the state of at least one elevator associated with the location from an idle state to an active state.

2. The method of claim 1, wherein obtaining, by a controller of an elevator system, a sensor event associated with a location in a building, comprises:
obtaining, by the controller, the sensor event associated with the location in the building from an elevator system node, the sensor event indicating an event detected by the elevator system node.

3. The method of claim 2, wherein the event detected by the elevator system node comprises at least one of increased brightness, a motion event or a proximity event.

4. The method of claim 2, wherein the elevator system node comprises a destination operating panel, a destination guide, an intelligent landing call station or a sensor node.

5. The method of claim 1, wherein obtaining, by a controller of an elevator system, a sensor event associated with a location in a building, comprises:
obtaining, by the controller, the sensor event associated with the location in the building from a building system, the sensor event indicating an increased power consumption of at least one system node at the location.

6. The method of claim 1, wherein changing, by the controller, the state of at least one elevator associated with the location from an idle state to an active state, comprises:
changing, by the controller, the state of an elevator closest to the location.

7. A controller of an elevator system, the controller comprising:
means for obtaining a sensor event associated with a location in a building; and
means for changing, the state of at least one elevator associated with the location from an idle state to an active state.

8. The controller of claim 7, wherein the means for obtaining are configured to obtain the sensor event associated with the location in the building from an elevator system node, the sensor event indicating an event detected by the elevator system node.

9. The controller of claim 8, wherein the event detected by the elevator system node comprises at least one of increased brightness, a motion event or a proximity event.

10. The controller of claim 8, wherein the elevator system node comprises a destination operating panel a destination guide, an intelligent landing call station or a sensor node.

11. The controller of claim 7, wherein the means for obtaining are configured to obtain the sensor event associated with the location in the building from a building system, the sensor event indicating an increased power consumption of at least one system node at the location.

12. The controller of claim 7, wherein the means for changing are configured to change the state of an elevator closest to the location.

13. An elevator system comprising:
at least one elevator; and
the controller of claim 7.

14. A computer program embodied on a non-transitory computer readable medium and comprising program code, which when executed by at least one processing unit, causes a controller to perform the method of claim 1.

15. (canceled)

16. The method of claim 3, wherein the elevator system node comprises a destination operating panel, a destination guide, an intelligent landing call station or a sensor node.

17. The method of claim 2, wherein changing, by the controller, the state of at least one elevator associated with the location from an idle state to an active state, comprises:
changing, by the controller, the state of an elevator closest to the location.

18. The method of claim 3, wherein changing, by the controller, the state of at least one elevator associated with the location from an idle state to an active state, comprises:
changing, by the controller, the state of an elevator closest to the location.

19. The method of claim 4, wherein changing, by the controller, the state of at least one elevator associated with the location from an idle state to an active state, comprises:
changing, by the controller, the state of an elevator closest to the location.

20. The method of claim 5, wherein changing, by the controller, the state of at least one elevator associated with the location from an idle state to an active state, comprises:
changing, by the controller, the state of an elevator closest to the location.

21. The controller of claim 9, wherein the elevator system node comprises a destination operating panel a destination guide, an intelligent landing call station or a sensor node.
